(19) United States
(12) Patent Application Publication
(10) Pub. No.: US 2011/0154478 A1
(43) Pub. Date: Jun. 23, 2011

(54) ELECTRONIC DEVICE SECURITY

(76) Inventor: Yen Hsiang Chew, Penang (MY)

(21) Appl. No.: 12/909,102

(22) Filed: Oct. 21, 2010

(30) Foreign Application Priority Data
Dec. 23, 2009 (MY) PI 20095547

(51) Int. Cl. G06F 21/00; G05B 23/02; H04L 9/32

(52) U.S. Cl. 726/16; 340/3.1; 726/26

(57) ABSTRACT

An apparatus comprises logic to manage data access in an electronic device by performing operations, comprising detecting at least one of a motion, vibration or change in orientation of the electronic device and in response to a detection, implementing a security policy for the electronic device. Other embodiments may be described.

### RELATED APPLICATIONS

This application claims the benefit of priority under 35 U.S.C. §119(a)-(d) and (f) of Malaysian Patent Application No PI20095547, filed Dec. 23, 2009, the disclosure of which is incorporated herein by reference in its entirety.

### BACKGROUND

The subject matter described herein relates generally to the field of electronic devices and more particularly to security in electronic devices.

Some electronic devices may be susceptible to data loss due to theft of the electronic device. This problem is exacerbated in mobile computing devices which include a power management system such as the Advanced Configuration and Power Interface (ACPI) system because users frequently choose simply to close the lid on their device rather than to completely shut down the device. Thus, when an electronic device is stolen the data is accessible to the thief when the lid is opened, which restarts the system.

In some instances the data resident on the device is confidential, and may be far more valuable than the electronic device. Accordingly techniques to safeguard data in the event that an electronic device is stolen or is subject to an unauthorized access by a user may find utility.

### BRIEF DESCRIPTION OF THE DRAWINGS

The detailed description is described with reference to the accompanying figures.

FIG. 1 is a schematic illustration of an exemplary system which may be adapted to implement data protection in accordance with some embodiments.

FIG. 2 is a flowchart illustrating operations in a method to implement electronic device security, according to embodiments.

FIGS. 3 and 4A-4B are schematic illustrations of an exemplary environment in which to implement data protection in accordance with some embodiments.

FIG. 5 is a schematic illustration of a system which may be adapted to implement data protection, according to an embodiment.

### DETAILED DESCRIPTION

Described herein are exemplary systems and methods to implement data protection in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

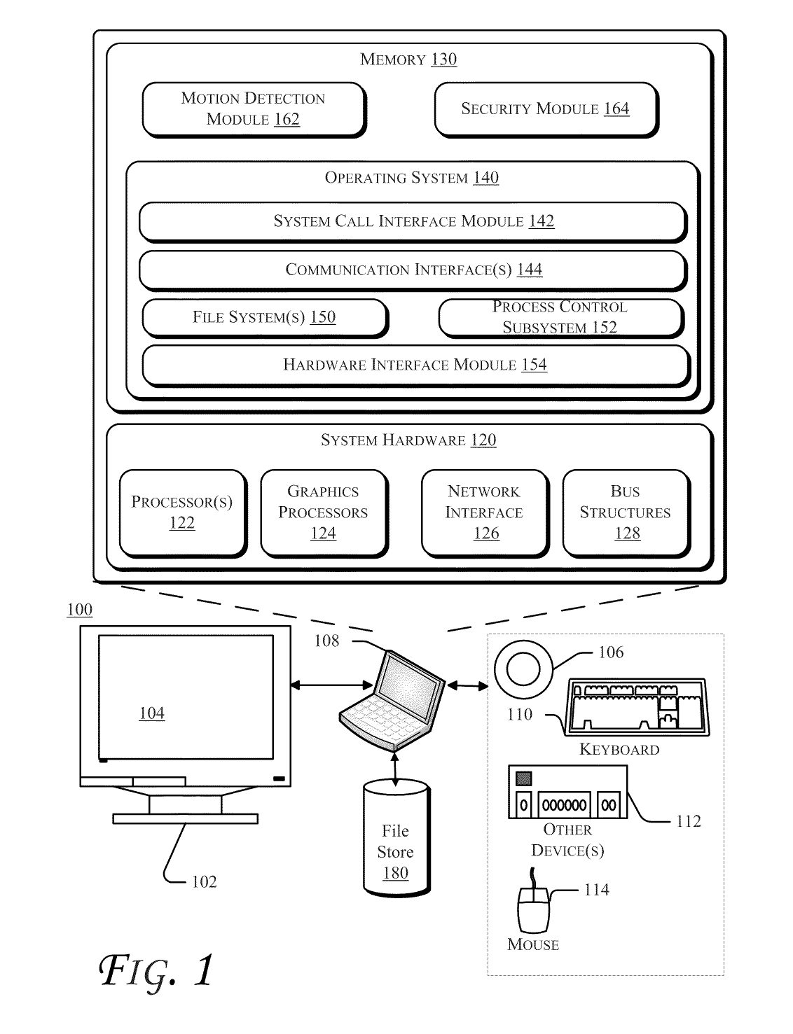

FIG. 1 is a schematic illustration of an exemplary system which may be adapted to implement data protection in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

In various embodiments, the electronic device 108 may be embodied as a personal computer, a laptop computer, a personal digital assistant, a mobile telephone, an entertainment device, a consumer electronics device or another computing device.

The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, one or more graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In one embodiment, memory 130 includes a motion detection module 162 to detect motion or orientation changes of computing device 108. Memory 130 further comprises a security module 164 to implement one or more data protection policies. In one embodiment, the motion detection module 162 and the security module 164 may be embodied as logic instructions stored in the computer readable memory module 130 of the system 100. In other embodiments the motion detection module 162 and the security module 164 may be reduced to firmware which may be stored with a basic input/output system (BIOS) for the system 100, or to hardwired logic circuitry, e.g., an integrated circuit (IC). Additional details about the operations implemented by graphics processor selection module are described below.

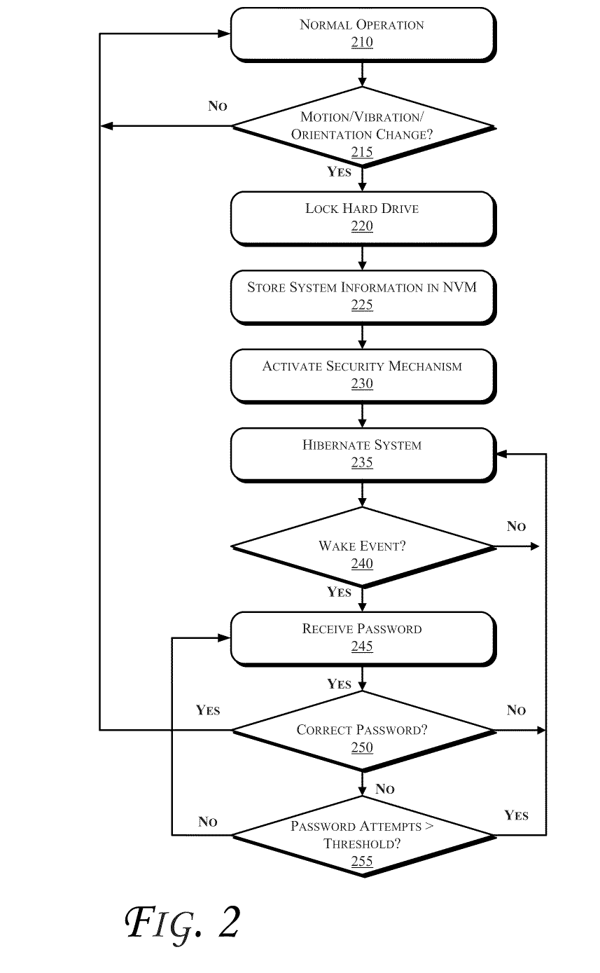

FIG. 2 is a flowchart illustrating operations in a method to implement electronic device security, according to embodiments. In some embodiments the subject matter described herein protects systems with an unlocked user-interface from being stolen and used (e.g. an unattended laptop being stolen or a mobile computing device being snatched). The subject matter described herein also provides protection for systems with locked user-interface from being stolen and tampered with.

By way of overview, in some embodiments a system is able to detect motion, vibration and/or change in chassis orientation in response to being moved. Further, a system comprises a first-level non-volatile memory (NVM) storage (e.g. solid state disk or flash device and an optional second-level mechanical storage hard drive. With NVM memory and motion detection functionality, a system can detect motion or orientation changes and locks and spin off its mechanical hard drive while storing system information and recovery information into a specified location in NVM. This may be safely done even when system is being moved around. System information is automatically stored into NVM and may be stored encrypted, so that its proper owner can bring the system out of hibernation later using his personal password.

If volatile memory (DRAM/SRAM) needs to be powered off during hibernation, then NVM will ensure that system will be able to recover to its pre-hibernation state when a wake event is detected and a correct user password is entered. In some hibernation state, system memory contents will be copied to hard-drive before system goes into hibernation. Hence adding a NVM ensures that the operation of storing DRAM information into NVM may still occur without damaging the storage device as in the case of a magnetic storage device when system is being moved around (as in the case of a snatch event or simply by a user who wants to move a system from one place to another) However, in one embodiment where volatile memory e.g. DRAM will not be powered off during hibernation then there may not be a need for the additional NVM. System information may be stored in volative memory instead provided there is sufficient capacity.

In some embodiments, volatile memory may be insufficient (not enough memory) to store system state information in its complete form. This could happen if system (volatile) memory is fully utilized by user programs and/or system programs; and system may resort to using virtual memory (paging to hard-drive). When this happens, system will not be able to go into hibernation immediately upon detection of motion without losing system state information or without the risk of damaging its magnetic hard-drive. NVM ensures that system can always go into hibernation upon detection of motion irrespective of the state of its system memory utilization and irrespective of whether system memory is eventually powered off in a hibernation state.

In one embodiment, system may reserve a segment of memory in system (volatile) memory for storing state information upon hibernation; hence this memory will not be available to conventional programs for user. However, with this setup, system can go into hibernation upon detection of motion without the need for a NVM provided the volatile memory remains powered-on during hibernation.

Thus, referring to FIG. 2, at operation 210 the system is in a normal operation state. If, at operation 215 motion, excessive vibration, or a change in orientation is detected then control passes to operation 220 and the hard drive is spun off and locked. At operation 225 system information is stored in nonvolatile memory. Optionally, the system information may be encrypted.

At operation 230 one or more security mechanisms maybe activated. Among some of these security features may include some features found in Intel's AMT/Intel's Anti-Theft Technology, and hard drive locking. System user interface will also be automatically locked. At operation 235 the system is placed in a hibernation state.

If, at operation 240 a wake event occurs then control passes to operation 245 and the system receives a password, typically via a user interface. If, at operation 250 the password is correct then control passes to operation 210 and the system resumes normal operation. By contrast, if at operation 250 the password is incorrect then control passes to operation 255, where it is determined whether the number of password attempts exceeds a threshold. If it does not, then control passes back to operation 245 and the user is allowed to enter a new password. If the threshold is exceeded, then control passes to operation and the system is hibernated.

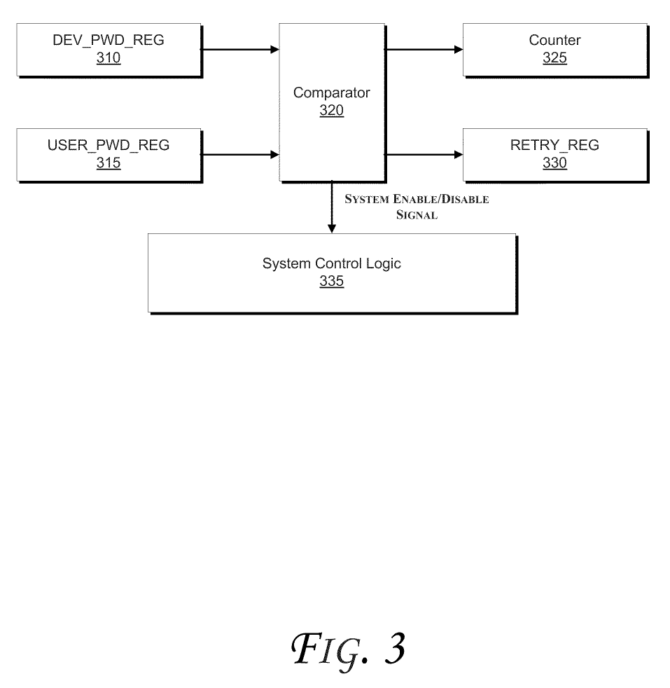

In other embodiments the system may implement an automatic locking mechanism. FIGS. 3-5 are schematic illustrations of an exemplary system in which to implement data protection in accordance with some embodiments. Referring to FIG. 3, in one embodiment the system comprises several registers which may be implemented in a processor or a chipset. The registers comprise a DEV_PWD_REG register 310, which is a non-volatile write only register inside the CPU or chipset for storing a password, a USER_PWD_REG register 315, which is a volatile write only register for user to enter a password. Contents inside this register will be reset when system goes into a low power state. The system further comprises a RETRY_REG non-volatile internal register 330 inside CPU or chipset for keeping track of the number of times a user attempts to enter a password, and a counter 325.

In some embodiment the DEV_PWD_REG 310 and USER_PWD_REG 315 are inside a CPU or chipset. A comparator 320 asserts a system enable signal during normal operation mode if the value of DEV_PWD_REG 310 equals the value of USER_PWD_REG 315. The system enable/disable signal may be used to throttle system control logic 335 from functioning when de-asserted; thus crippling a system.

In operation an initial password may be set into DEV_PWD_REG 310 by system administrator or user. For example, the DEV_PWD_REG 310 may be programmed with a value PWD_X. The same password PWD_X must be written to USER_PWD_REG 315 to assert a system enable signal from comparator 320. If USER_PWD_REG 315 does not contain PWD_X then the system enable will be de-asserted. PWD_X may be derived from a user password through several mechanism, including but not limited to hashing a user password to obtain PWD_X, using a user password to access the user's public key for unlocking PWD_X, or any other suitable means of mapping a user password to PWD_X.

When system is powered on the value of USER_PWD_REG 315 is reset to zero. However non-volatile DEV_PWD_REG 310 will still contain PWD_X. A user may enter his password to logon to the system and the same password will be used to generate PWD_X. The system may then write PWD_X to USER_PWD_REG 315 to assert a system enable signal from comparator 320 before bringing the system to full user functionality. If a wrong password is entered, the comparator will de-assert the system enable signal from system control logic 335 and the system will not be able to go to full user functionality. Further, a warning may be issued to user to re-enter his password.

When a system enters a low power state; some if its platform power rails may be turned off to conserve power; by placing USER_PWD_REG 315 in the section of silicon or platform powered by that power rail; power to this register will automatically be turned off during low power states and its contents will be cleared. Clearing USER_PWD_REG 315 may also be accomplished by having additional hardware to clear it whenever a low power state is entered (e.g. when system goes into hibernation mode). User may re-enter his password to re-enable a system enable signal from comparator 320.

In low power mode, clocks to some parts of the silicon or platform may be gated or power may be removed from them. The comparator 320 may then de-assert the system enable signal to prevent that part of the silicon or platform from being un-gated or prevent them from being powered-on again if remain de-asserted. This will not affect normal operation of the system as part of the system control logic 335 throttled by the system enable signal will be non-functional anyway in a low power state. However the comparator 320 must re-assert the system enable signal before system can exit from its low power state. Thus, a stolen system will be crippled (i.e., part of the silicon or platform will always be non-functional) if a user cannot produce the correct password. In other embodiments, multiple sets of PWD_REG registers may be placed in different sections of silicon or platform to protect different parts of the system.

To prevent systematic guessing of the user's password, another non-volatile register RETRY_REG 330 may be added to the present embodiment. Whenever a user wrongly enters a password into USER_PWD_REG 315, value of RETRY_REG 330 will be incremented by 1. A maximum N number of attempts are allowed before USER_PWD_REG 315 permanently locks up causing the comparator 320 to permanently de-assert the system enable signal to system control logic 335. When a correct password is entered RETRY_REG 330 will be reset to zero. RETRY_REG 330 is non-volatile to prevent its contents from being reset when power is removed from system; this ensures that the number of attempts at guessing the right password will not exceed N. If system locks up, a system administrator may unlock USER_PWD_REG 315 using a secure unlocking mechanism. A non-volatile write-only system password register may be added to the present embodiment. This register may contain a system password pre-set by system administrator to unlock the system in case a system locks up after N unsuccessful attempts at entering a correct password.

In summary, the components shown in FIG. 3 may be implemented in various areas of the silicon, chipset and platform to systematically lock these sections of the platform when a low power state is entered. A user password register is automatically reset to zero when a low power state is entered to de-assert the system enable signal. The only way the system enable signal can be re-asserted again after a low power state is reached is for a user to enter his correct user password. The method of clearing USER_PWD_REG 315 may be accomplished through placing this register inside a section of silicon or platform that will be powered off when a low power state is entered. Both DEV_PWD_REG 310 and USER_PWD_REG 315 registers are write only registers, so that password stored inside the register is secure and cannot be accessed. To prevent systematic guessing of device password, another non-volatile register and a counter may be integrated into the password protection system. Counter 325 increments the content of the counter register 330 whenever a wrong password is entered until N attempts has been made, and system will be locked. If a right password is entered counter register will be reset to zero.

In some embodiments the system may be used to prevent a stolen system from being used as long as the user has placed his mobile system in hibernation mode irrespective of whether system is powered down. Depending on where the invention is implemented, if the invention is present in all CPU, chipset and peripheral devices including storage devices then all the above mentioned devices may be disabled if a user does not have the correct password, even if user attempts to disassemble a stolen system to harvest individual components (e.g. processor & chipsets) or to attempt to access data stored in its storage components. These individual components will also be disabled if invention is implemented in each of these components.

Novel features of the system include using a non-volatile register for storing device password and a volatile register for user to enter his password. Both registers are write-only to protect the password. Further, the user password register is automatically reset whenever system enters into a low power state. This may be accomplished by putting that register in a section of silicon or platform that will be powered off during a low power state. Still further, the password register controls a system enable signal. This signal is used to prevent the part of silicon or platform that has been clock gated or powered down during a low power state from resuming its normal functionality if the correct password is not entered. The apparatus and method to prevent systematic guessing of password by having a third non-volatile register as a counter register to limit the number of attempts at guessing a password.

Unique features of the system of FIG. 3 further include a locking mechanism that is hardware supported and integrated into the CPU, chipset or components; this feature makes a stolen system virtually impossible to hack. Further, components for entering a password may be integrated in multiple locations of a platform. These locations may be powered by different power rails. Still further, the locking mechanism is automatically enabled when any low power state (C state, P state or S state) is entered without having to go to hibernation mode or without being shutdown. As long as entering that low power state disables part of a system either through clock gating or through removal of power from some power rails. Finally, the system automatically locks up after N unsuccessful attempts at guessing a correct password irrespective of whether the system has been powered down between successive attempts.

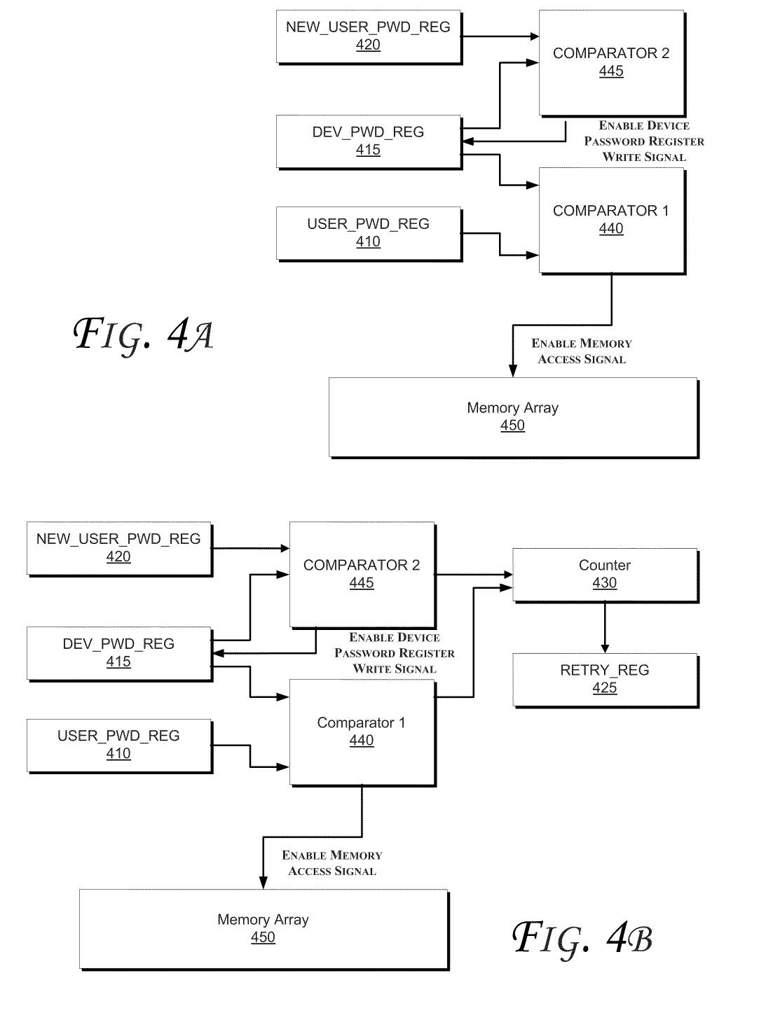

In some embodiments the system of FIG. 3 may be modified to include additional registers and additional hardware to support additional functionality. Referring to FIGS. 4A and 4B, in one embodiment the system may have 4 registers: a DEV_PWD_REG 415 is a non-volatile write only register inside the storage device for storing a device password, USER_PWD_REG 410 a volatile write only register for user to enter password for activating device, NEW_USER_PWD_REG 420 is a write only register, which may be volatile or non-volatile, may be used together with DEV_PWD_REG 415 for changing device password, and RETRY_REG 425 non-volatile internal register (non-accessibly by user) inside the system for keeping track of the number of times a user attempts to enter a device password

Referring to FIG. 4A, an initial password may be set into DEV_PWD_REG 415 by a system administrator using a secure hardware unlocking mechanism. Contents inside the memory array 450 can only be access (written to, read or both) if the value of DEV_PWD_REG 415 equals the value of USER_PWD_REG 410. In some embodiments DEV_PWD_REG 415 is programmed with value PWD_X; a component that wants to access memory array 450 will write PWD_X into USER_PWD_REG 410 to unlock memory array 450. After accessing and/or modifying the contents of memory array 450, a component may write to USER_PWD_REG 410 a value that is different from PWD_X (e.g. all 0 or all F) to re-lock memory array 450 or simply leave the device unlocked. Device will be automatically locked when powered down or when system goes into a low power state as USER_PWD_REG 410 is volatile and does not retain its value after power down. This mechanism enables a system to be automatically locked when powered down. PWD_X may be a user defined password, a user's security key, a hashed output of a user's password or any binaries which length is equal to the length of DEV_PWD_REG.

The value of DEV_PWD_REG 415 can only be over-written if its value is equal to the value of NEW_USER_PWD_REG 420. When value of DEV_PWD_REG 415 is equal to the value of NEW_USER_PWD_REG 420, COMPARATOR 2 will assert an ENABLE DEVICE PASSWORD REGISTER (DEV_PWD_REG) WRITE SIGNAL to enable DEV_PWD_REG to be written to. Comparator 1 works in an analogous fashion.

To reset a device password the following atomic operations must be supported to ensure that a password is changed without external interference.

1. Authenticate the user and check for system privilege to change the password of the device. This may be done through a secure system entry protocol.

2. Write the user's original password into NEW_USER_PWD_REG 420. At this stage, the value in DEV_PWD_REG 415 will equal the value in NEW_USER_PWD_REG 420; hence contents inside DEV_PWD_REG 415 can be overwritten.

3. Write the new password into DEV_PWD_REG 415 thereby updating the password and locking the system at the same time.

4. Steps 2 and 3 must be performed atomically; this can be achieved by locking of processor resource and system buses when performing the 2 write operations. The atomic operation can also be accomplished by having a mechanism that takes-in 2 passwords as a single IO operation and then internally write the first (original) password into NEW_USER_PWD_REG 420, and the second (new) password into DEV_PWD_REG 415.

It can be seen that the new password is stored in a location that is write only and its value is retained until a new password is written to it. Hence the password is securely stored inside the device. To prevent a hacker from systematically guessing the password, another non-volatile register RETRY_REG 425 (see FIG. 4B) may be added to the present embodiment. Whenever a user wrongly enters a password into USER_PWD_REG 410 or NEW_USER_PWD_REG 420; value of RETRY_REG will be incremented by 1. A maximum N number of attempts are allowed before MEM_DEV permanently locks up (e.g. USER_PWD_REG 410 and NEW_USER_PWD_REG 420 may no longer be written to). If this happens, only a system administrator may unlock MEM_DEV using a secure hardware unlocking mechanism. When a correct password is entered RETRY_REG 425 will be reset to zero. RETRY_REG 425 is non-volatile to prevent its contents from being reset when power is removed from MEM_DEV; this ensures that the number of attempts at guessing the right password will not exceed N. This feature prevents password protected storage devices of a stolen system from being accessed, by limiting the number of attempts at guessing the password of MEM_DEV.

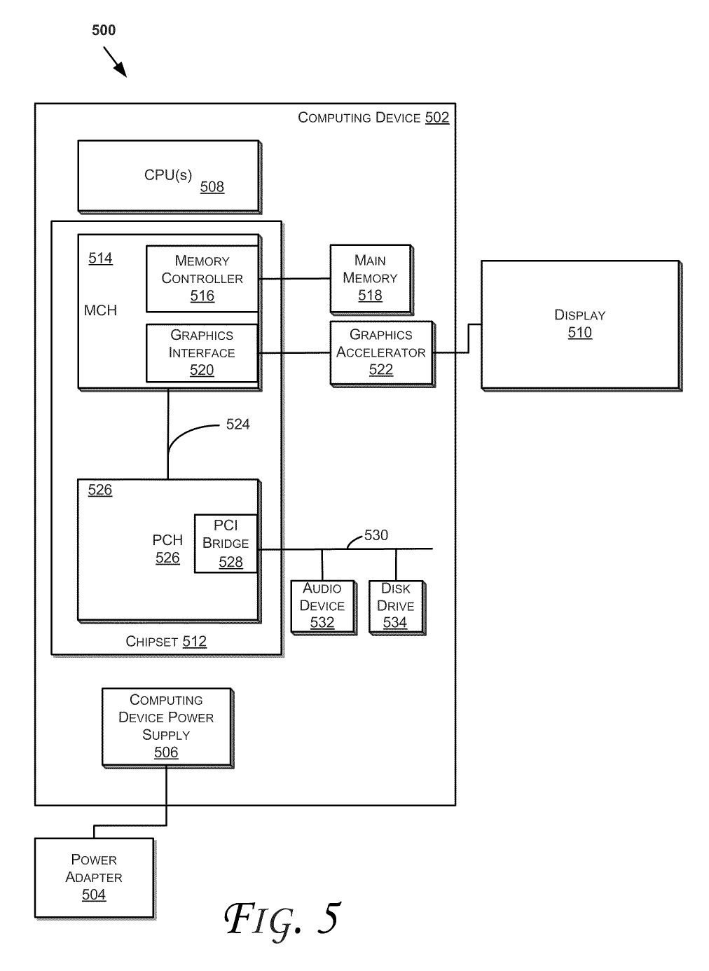

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110 VAC to 240 VAC) to a direct current (DC) voltage ranging between about 7 VDC to 12.6 VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 510 may be coupled to the graphics interface 520 through, for example, a signal converter that translates a digital representation of an image stored in a storage device such as video memory or system memory into display signals that are interpreted and displayed by the display. The display 510 signals produced by the display device may pass through various control devices before being interpreted by and subsequently displayed on the display.

A hub interface 524 couples the MCH 514 to a platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
logic to manage data access in an electronic device by performing operations, comprising:
detecting at least one of a motion, vibration or change in orientation of the electronic device; and
in response to a detection, implementing a security policy for the electronic device.

2. The apparatus of claim 1, wherein the security policy comprises:
spinning off a hard drive in the electronic device; and
storing system information and recovery information in nonvolatile memory.

3. The apparatus of claim 2, wherein the security policy further comprises encrypting the system information and recovery information in a nonvolatile memory.

4. The apparatus of claim 1, wherein the security policy comprises locking a system user interface.

5. The apparatus of claim 1, wherein the security policy comprises:
forcing a login procedure when the electronic device restarts; and
permanently locking the electronic device in response to a predetermined number of login failures.

6. A method to manage data access in an electronic device comprising a housing and a processor, the method comprising:
detecting at least one of a motion, vibration or change in orientation of the housing; and
in response to a detection, implementing a security policy for the electronic device.

7. The method of claim 6, wherein the security policy comprises:
spinning off a hard drive in the electronic device; and
storing system information and recovery information in nonvolatile memory.

8. The method of claim 7, wherein the security policy further comprises encrypting the system information and recovery information in nonvolatile memory.

9. The method of claim 6, wherein the security policy comprises locking the system user interface.

10. The method of claim 6, wherein the security policy comprises:
forcing a login procedure when the system restarts; and
permanently locking the system in response to a predetermined number of login failures.

11. An apparatus, comprising:
a first nonvolatile register;
a volatile register; and
logic to manage access to the electronic device by performing operations, comprising:
storing a first password into the first nonvolatile register;
receiving, via a user interface, a second password during a power-up operation;
storing the second password in the volatile register; and
enabling the system to complete power-up operations when the second password corresponds to the first password.

12. The apparatus of claim 11, further comprising a second nonvolatile register, and logic to:
store a number of failed login attempts in the second nonvolatile register; and
disable at least a portion of the electronic device when the number of failed login attempts exceeds a threshold.

13. The apparatus of claim 11, further comprising logic to reset the volatile register when the electronic device is powered on.

14. The apparatus of claim 11, further comprising logic to reset the volatile register when the electronic device transitions from an operational state to a low-power state.

15. The apparatus of claim 11, further comprising logic to generate a hash of the second password.

16. The apparatus of claim 11, further comprising logic to use the second password to access a public key to decrypt the second password.

17. The apparatus of claim 11, further comprising a comparator which generates a signal based on the first password and the second password as inputs.

18. The apparatus of claim 11, further comprising a write only register and logic to:
receive in the write only register, via a user interface, a new password for a user; and
store the new password in the first nonvolatile register only when the second password corresponds to the first password.

19. A method to manage access to an electronic device, comprising:
storing a first password in a first nonvolatile register in the electronic device;
receiving, via a user interface, a second password during a power-up operation;
storing the second password in a volatile register in the electronic device; and
enabling the system to complete power-up operations when the second password corresponds to the first password.

20. The method of claim 19, further comprising:
storing a number of failed login attempts in a second nonvolatile register; and
disabling at least a portion of the electronic device when the number of failed login attempts exceeds a threshold.

21. The method of claim 19, further comprising resetting the volatile register when the electronic device is powered on.

22. The method of claim 19, further comprising resetting the volatile register when the electronic device transitions from an operational state to a low-power state.

23. The method of claim 19, further comprising generating a hash of the second password.

24. The method of claim 19, further comprising generating, in a comparator, a signal based on the first password and the second password as inputs.

25. The method of claim 19, further comprising:
receiving in a write only register, via a user interface, a new password for a user; and
storing the new password in the first nonvolatile register only when the second password corresponds to the first password.
